(19) United States
(12) Patent Application Publication
(10) Pub. No.: US 2006/0230316 A1
(43) Pub. Date: Oct. 12, 2006

(54) Method ensuring normal operation at early power-on self test stage

(75) Inventors: Ying-Chih Lu, Taipei (TW); Meng-Hua Cheng, Taipei (TW); Chun-Yi Lee, Taipei (TW); Lung-Hung Yu, Taipei (TW); Chi-Tsung Chang, Taipei (TW); Chia-Hsing Lee, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/095,720

(22) Filed: Mar. 30, 2005

(51) Int. Cl. G06F 11/00

(52) U.S. Cl. 714/36

(57) ABSTRACT

A method for ensuring normal operation at an Early Power-On Self Test stage of a computer device is proposed. The method is applied to the computer devices having a timing function. A largest execution time for at least an Early POST program is preset, and the actual execution time of the Early POST program is counted when the computer device is activated. If the execution time of the POST program is greater than the largest execution time, the computer devices will then be restarted, the POST program will be re-executed, and the timing process of the POST program will be performed again, until execution time of every Early POST programs is smaller or equal to the corresponding preset largest execution time. Upon which, the timing will be terminated, and the computer devices will be able to enter into the stage of Later POST. This method ensures any Early POST program causing the system to hang to be cleared by automatically restarting the computer system, so that users will not experience system hangs during the Early POST stage.

### FIELD OF THE INVENTION

The present invention relates to a method of ensuring normal operation of booting computer device, and more particularly, to a method of ensuring normal operation of a computer device at an Early Power-On Self Test (Early POST) stage.

### DESCRIPTION OF THE PRIOR ART

According to the rapid growth of electronic information related technologies, many powerful information related products with reasonable prices have been continuously introduced into the market. Taking computer facilities as an example, no matter large scale super computers, server hosts, personal computers or notebooks, all of these are important tools and they have been playing an essential role in people's works and lives today.

In most configurations of a computer system, BIOS (i.e. Basic Input Output System) is the first software in the system to be executed when powered on. BIOS is mainly composed of lower level instruction sets (programs), providing hardware tests, detection and management of data transmission between peripheral devices (such as hard disk and keyboards) and connection ports during the power-on process. Hence, after turning on, the computer system operates according to the BIOS setting. If problems occur in the BIOS, hardware tests cannot be completed; therefore the power-on procedures cannot be successfully completed. In general, the main flow of the power-on process of the computer system is that after a user turns on the power, the computer system activates an Early Power-On Self Test (Early POST), then a Later Power-On Self Test (Later POST) and finally an Operating System (OS) Boot.

However, during the development of computers, new-model chipsets or SIO (i.e. Super IO chipset) are not compatible with the present Hardware designs, or there are bugs in the chipsets themselves, causing problems in the system at the stage of Early POST (i.e. when video signals are not yet transmitted to computer monitors), thus the whole system hangs and locks the power-on procedure. All those problems described above such as Dead Lock or Live Lock can occur at the stage of Early POST. Dead Lock means direct system hang, the central processing unit (CPU) cannot fetch any command to execute programs. Live Lock means the CPU can fetch commands to execute programs, but always execute a segment of a certain program, that is, there is an endless loop being executed at the segment, hence the following programs cannot progress. Both of the situations (Dead Lock and Live Lock) will cause system hangs. Computer dealers have been bothered with those mentioned above, hence, several problems arise as described below: when a problem of Dead Lock or Live Lock (e.g. a certain segment of a certain program) occurs during system power-on test process, the problem will then be removed by the dealer, and the system is retested. However, these kinds of problems may still happen in another segment of the programs, again, these problems will be removed by the dealers. Similar situations may occur over and over again which leads to repetitive power-on testing failures, and as a result, the computer cannot be delivered as a selling product. Moreover, problems of Dead Lock and Live Lock are unpredictable, if the problems do not appear at the time of debugging, these products will be delivered to customers. However, the problems may pop up again when the system is turned on by the customers, consequently, the reliability of the products is not ensured.

From the above discussion, how to make a computer system operating normally at the testing stages to accomplish successful shipment and to ensure customers' satisfactions are urgent problems waiting to be solved by the dealers.

### SUMMARY OF THE INVENTION

In order to solve the problems of the prior art, a primary objective of the present invention is to provide a method of ensuring normal operation of computer systems at the stage of Early Power-On Self Test (Early POST), allowing computer systems to successfully enter into the stage of Later Power-On Self Test (Later POST).

In accordance with the above and other objectives, the present invention proposes a method for ensuring normal operation at the stage of Early POST. The method is applied to a computer device, allowing the avoidance of Dead Lock or Live Lock which causes the computer device to hang at the stage of Early POST, so it can then enter into the Later POST stage successfully. The computer device has at least one POST program. The method mainly comprises the steps of presetting a largest execution time for the POST program by the computer system, activating system of the computer device, executing the POST program, and counting the time consumed by the POST program in order to generate an execution time. If the execution time of any POST program is greater than the preset largest execution time, restarting the computer device and re-executing the Power-On Self Test program. Then the counting the time consumed by the POST program again. These steps continue until all the POST programs are smaller or equal to the largest execution time, at that time, stopping the timing and entering the computer device into the Later POST stage, thus achieving the primary objective of the present invention.

### BRIEF DESCRIPTION OF THE DRAWINGS

A better understanding of the present invention can be obtained when the following detailed description is considered in conjunction with the appended drawings, in which:

FIG. 1 is a flow chart of the method for ensuring normal operation at an Early Power-On Self Test stage of a computer device according to one embodiment of the present invention; and

FIGS. 2A-2D are flow charts showing various kinds of embodiments for implementing the method for ensuring normal operation at the Early Power-On Self Test stage of the present invention.

### DETAILED DESCRIPTION OF THE PREFERRED EMBODIMENT

The descriptions below of specific embodiments are to illustrate the present invention. Others skilled in the art can easily understand other advantages and features of the present invention from contents disclosed in this specification. The present invention can be carried out or applied through different embodiments. Every details of this specification can be modified based on different viewpoints and applications yet still within the scope of the present invention.

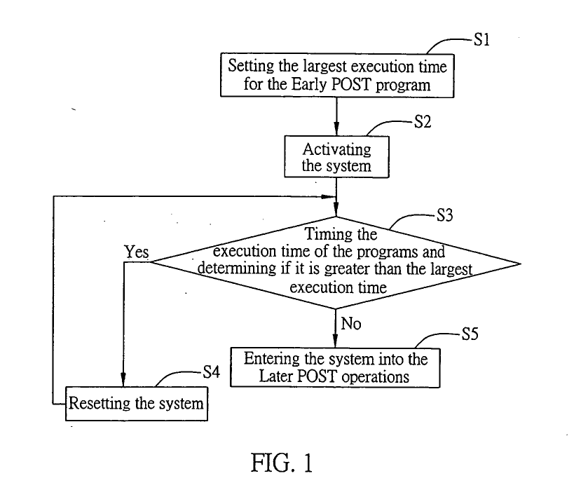

FIG. 1 illustrates a flow chart showing the method for ensuring normal operation at the Early Power-On Self Test stage of a computer system of the present invention. The preferred embodiment of the present invention is described in conjunction with this flow chart. Those steps that are unrelated to the present invention are not shown herein for conciseness.

The method for ensuring normal operation at the Early Power-On Self Test stage of the present invention is applicable to computer devices, allowing the occurrence of Dead Lock or Live Lock which causes the computer devices to hang at the stage of Early Power-On Self Test (Early POST), so that the computer devices can then enter into the Later Power-On Self Test (Later POST) successfully. The computer device has at least a POST program, for instance testing programs for detecting errors in each system elements (e.g. main memory units, disk drives and keyboards), and the POST program(s) can be installed in memory units like BIOS ROM, etc.

In the method for ensuring normal operation at the Early POST stage of the computer device of the present embodiment as shown in FIG. 1, S1 is performed. In S1, a largest execution time for POST program is preset in the computer device. This time-setting step can be achieved through, for instance, chipsets with timing function (i.e. chipsets with timers). In other words, the largest execution time of the Early POST program provided in the computer device can be set through the chipsets. Generally, the time-setting step is aiming at those programs in which commands of Dead Lock or Live Lock are more likely to be generated. According to those programs, the largest execution time i.e. the time consumed for executing the Early POST program (e.g. the execution time for detecting a host memory status is 10 seconds) is set in the aforementioned timer. After that, move on to step S2.

In step S2, the computer system is turned on, and then the one or more Early POST programs are activated. After that, move on to step S3.

In step S3, the computer device times the execution time of the Early POST programs activated in step S2 and determines whether the execution time of any one of the Early POST programs is greater than the largest preset execution time in the step S1. If the execution time of any program is greater than the largest execution time preset in the step S1, for example, if the execution time for detecting the main memory units status runs greater than 10 seconds, then move to step S4. If the execution time of every program is smaller than or equal to the largest execution time, move on to step S5.

In step S4, the computer device is restarted. The resetting step is due to that the execution time of any one of the executed Early POST programs being greater than the preset largest execution time (also referred to as a “time out” phenomenon). As a result of the system reset, all POST programs are re-executed. After that, go back to step S3. Generally, the occurrence of this time out is because somewhere in the Early POST programs, a Dead Lock or Live Lock commands have already been generated, leading to the hang of the computer device, and resulting in the execution time (i.e. the clocked execution time) of the program greater than the largest execution time of the program. The present invention is achieved by the utilization of the aforementioned timer actively sends out the resetting signals to make the computer device restart automatically when system lock is encountered, so any system lock of the computer device during Early POST stage will not be noticed by the user.

In step S5, the computer device is entered into the Later POST stage. This step arrived at when the execution time of each of the Early POST programs is smaller than or equal to the largest execution time. As a result, the timing process is terminated and the computer device is entered into the Later POST. Because that the execution times of all the Early POST programs are within the normal time (i.e. smaller than or equal to the largest execution time), therefore, the computer device successfully proceed to the following power-on procedures. The following power-on procedures do not belong to the technical features of the present invention so they will not be described in detail. The computer device mentioned above can be, but not limited to, a super computer, a server host, a desktop computer or a notebook.

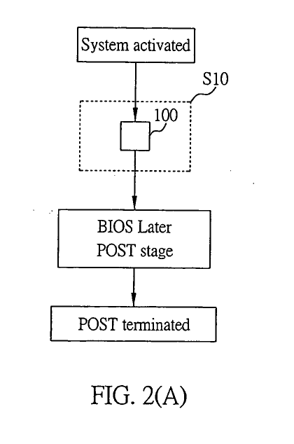

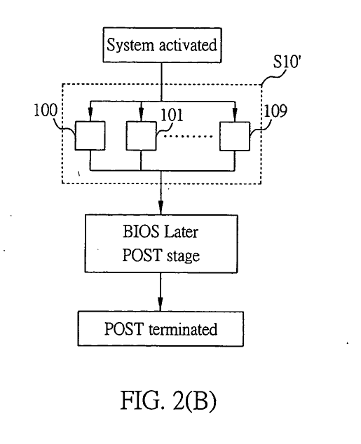

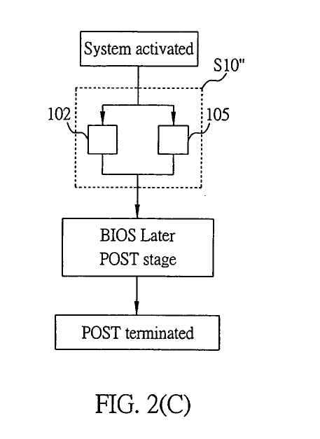

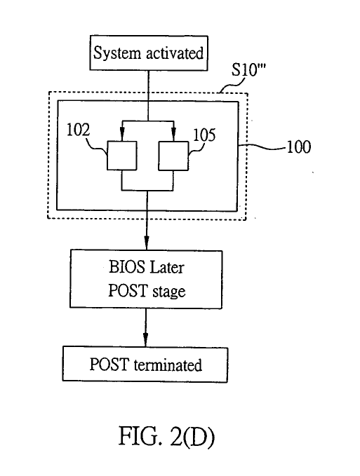

For further detailed descriptions, FIGS. 2A-2D show various embodiments of the method of the present invention applied to the real operation flow of the computer device. The blocks, numbers and quantities in these figures are presented as illustrations not limitations. FIG. 2A shows the first embodiment of the present invention. This embodiment only aims at one program 100 at the BIOS Early POST stage S10, i.e. this testing program is the only program executed in BIOS Early POST stage S10, after the system of the computer devices is activated. FIG. 2B shows the second embodiment of the present invention. This embodiment aims at all POST programs 100˜109 at the BIOS Early POST stage S10′, i.e. the testing programs 100˜109 are all executed in the Early POST stage S10′, after the system of the computer devices is activated. FIG. 2C shows the third embodiment of the present invention. This embodiment aims at a part of POST programs 102 & 105 at the BIOS Early POST stage S10″, i.e. testing programs 102 & 105 are executed in the Early POST stage S10″, after the system of the computer devices is activated. FIG. 2D shows the fourth embodiment of the present invention. This embodiment aims at a POST program 100 and a portion of the POST program 102 & 105 at the BIOS Early POST stage S10′″, i.e. testing program 100 is the only program executed in the Early POST stage S10′″, and testing programs 102 & 105 are included in the testing program 100), after the system of the computer devices is activated. Therefore, the method of the present invention can be modified based on different applications and requirements of the users.

Form the above, the method for ensuring normal operation at the stage of Early POST of the computer device according to the present invention is achieved by setting the largest execution time of Early POST programs of the computer device and performing the timing function provided in the computer device after the computer device is activated and when the POST programs are executed. If the execution time of any POST program is greater than the preset execution time, then, the computer device will be restarted, all the POST programs will be re-executed, and the timing will also be performed again for all the POST programs, until the execution time of all the POST programs is smaller than or equal to the largest preset execution time mentioned above. The computer device can then enter into the Later POST stage to perform a normal system flow. The present invention not only enables the dealers to pass the computer devices through system testing quickly, but also ensures the quality of the products delivered to customers. The chipsets (e.g. Intel ICH series) or SIO (Super IO chipset) in the market are all provided with timer, hence there is no further cost for implementing such function. The objective of the present invention, i.e. let the computer device operates normally at the Early POST stage, can be achieved by utilizing the already-existed chipsets.

The embodiments described above are only to illustrate aspects of the present invention; it should not be construed as to limit the scope of the present invention in any way. While the invention has been described in detail with reference to specific embodiments thereof, it will be apparent in the art that various changes and modifications can be made, and equivalents employed, without departing from the scope of the claims.

What is claimed is:

1. A method for ensuring normal operation at an Early Power-On Self Test (POST) stage of a computer device provided with at least one Early POST program to avoid a system hang of the computer device caused by either Dead Lock or Live Lock during the Early POST and to enable the computer device to enter into a Later POST stage, the method comprising the steps of:
(1) presetting a largest execution time for each of the at least one Early POST program by the computer device;
(2) activating the system of the computer device and executing the at least or Early POST program;
(3) counting execution time taken for executing each of the at least one Early POST program by the computer device, then if the execution time of any program is greater than the respective preset largest execution time, moving to step (4), and if every execution time is smaller than or equal to the respective largest preset execution time, moving to step (5);
(4) restarting the computer device and re-executing the at least one Early POST program, then returning to the step (3); and
(5) stopping the timing process of the computer device, and entering the computer device into the Later POST stage.

2. The method as claimed in claim 1, wherein the timing process is achieved by a timer.

3. The method as claimed in claim 2, wherein the timer is embedded in a chipset.

4. The method as claimed in claim 2, wherein the largest execution time is preset in the timer.

5. The method as claimed in claim 2, wherein a resetting signal will be actively sent out by the timer to reset the computer device, if any of the execution times of the if the Early POST program is greater than the preset largest execution time.

6. The method as claimed in claim 1, wherein the computer device is one selected from a group of a super computer, a server host, a desktop computer and a notebook.
